(19) United States
(12) Patent Application Publication
(10) Pub. No.: US 2011/0139024 A1
(43) Pub. Date: Jun. 16, 2011

(54) SAFETY ELEMENT HAVING INCIDENT AND TRANSMITTED LIGHT INFORMATION

(76) Inventor: Peter Schiffmann, Freising (DE)

(21) Appl. No.: 13/058,071

(22) PCT Filed: Aug. 7, 2009
(86) PCT No.: PCT/EP09/05755

§ 371 Date: Feb. 8, 2011

(30) Foreign Application Priority Data
Aug. 8, 2008 (DE) 10 2008 037 128.9

(51) Int. Cl. B41L 47/02; B41F 33/00; B42D 15/00

(52) U.S. Cl. 101/368; 101/483; 283/85

(57) ABSTRACT

A security element for a data carrier (1) includes a translucent substrate (3) which has a first partial area (4) with a first ink layer and a second partial area (5) with a second ink layer different from the first ink layer, wherein the first and second partial area, upon viewing in incident light, form a contiguous total area and produce a substantially identical visual impression, and wherein the first partial area, upon viewing in transmitted light, produces a brighter visual impression compared to the second partial area.

The invention relates to a security element for a data carrier with a window area, which comprises incident-light and transmitted-light information, a transfer element comprising such a security element for the application onto a data carrier, a data carrier with such a security element as well as method for manufacturing such a security element and such a data carrier.

Data carriers such as documents of value or identification documents, or also other objects of value such as for example branded products, for the purpose of their protection are provided with security elements, which allow the object to be authenticity-checked and which at the same time serve as a protection against unauthorized reproduction. Furthermore, security elements often produce a well visible optical impression, for the reason of which such security elements, besides their function as a security means, sometimes are used exclusively as decorative elements for such data carriers or for their packaging. A security element can be embedded in such data carriers, for example in a bank note or in a chip card, or be formed as a self-supporting transfer element, for example as a patch or as a label, which after its manufacturing is applied onto a data carrier or other object to be secured, for example over a window area of the data carrier.

Data carriers within the meaning of the present invention are in particular bank notes, shares, bonds, deeds, vouchers, checks, high-quality admission tickets, but also other papers at risk of forgery, such as passports or other identification documents, and also card-shaped data carriers, in particular chip cards, as well as product protection elements, such as labels, seals, packagings and the like. The term “data carrier” also comprises pre-stages of such data carriers which are still unfit for circulation, which for example in the case of security paper are present in quasi-endless form and are further processed at a later time.

Such data carriers can have window areas. These are light-transmissive areas with high translucency, preferably transparent areas. The window areas of a data carrier are formed for example by a recess or in the simplest case by a hole in the substrate of the data carrier.

Within the meaning of the present invention, a transparent area has a high light transmission of at least 90%, in the ideal case 100%, of the impinging visible light. For a viewer, a transparent area does not produce a changed impression with regard to color and/or the intensity of the light passing through the transparent area. A translucent area, however, recognizably decreases for a viewer the intensity of the light passing through and typically has a light transmission of 20% to 80%. Translucent areas can spectrally uniformly reduce the intensity of the light passing through, such as for example a grey filter, or have different light transmissions for different spectral ranges, such as for example a color filter. Glazing ink layers typically form translucent areas which have spectrally different light transmissions and thus produce a color impression to a viewer. The light transmission here depends on the layer thickness, so that with the help of a corresponding layer thickness the light transmission in a given spectral range can be reduced to the desired extent. An opaque area generally has a low light transmission of for example below 20%, preferably below 10%, and ideally of 0%. Opaque areas reduce the intensity of light passing through at least to a viewer in a spectrally uniform manner, so that possibly present different light transmissions for different spectral ranges are not perceived. Covering ink layers produce, depending on layer thickness and degree of covering, opaque or translucent areas with a light transmission which is spectrally uniform to the viewer.

Furthermore, in the present case a viewing, of for example a security element, in incident light means an illumination from a side and a for example perpendicular viewing of the security element from the same side. A viewing in incident light is thus present when the front of the security element is illuminated and also viewed. For determining the visual impression of a translucent area, the viewing in incident light preferably takes place against a white background.

In the present case, a viewing in transmitted light means an illumination of a security element from a side and a viewing of the security element from a different side, in particular the opposite side. A viewing in transmitted light is thus present for example when the back of the security element is illuminated and the front of the security element is viewed. The light thus shines through the security element and a viewer perceives the light passing through. In transmitted light, the visual impression resulting to the viewer is produced by the light transmission of the security element's different areas.

From WO 03/053713 A1 there is known a security element for window areas of a data carrier, which consists of a substrate in the form of a plastic carrier foil, on whose two opposing surfaces is disposed a security feature in each case. Between the security features there is located an all-over, opaque intermediate layer, so that upon viewing the security element from a side it is perceived only the one security feature which is disposed, in the viewing direction, on the front, and the back-side security element has no influence on the impression perceived.

From PCT/EP2008/001064 or DE 10 2007 030 219 there is known a further security feature for window areas in data carriers. The security element comprises a transparent carrier foil, which is printed with covering white grid dots. The dimensions of the grid dots are so small here that the individual grid dots cannot be perceived with the naked eye by a viewer. These grid dots are further printed on a front of the security element with a colored ink layer, so that there results for the viewer a front-side motif. On the back of the translucent substrate there is applied a further colored ink layer different from the first colored ink layer, so that there results for the viewer a back-side motif on the back of the security element. The covering white grid dots serve here as an opaque separation layer between the two motifs which in the simplest case are independent of each other. It is further proposed to print the back-side colored ink layer in a manner shifted to the covering white grid dots lying below, so that the back-side motif, upon viewing the front in incident light, can be recognized in a laterally reversed manner. It is further proposed to partly replace the covering white grid dots by a continuous covering white area, which a viewer can recognize upon viewing in transmitted light. As a further possibility to produce such a transmitted-light motif, it is proposed to partly remove by laser the covering white grid dots and the possibly further ink layer applied thereon, so that there results a completely transparent area in the form of a motif. Thus, the viewing of the front in incident light, the viewing of the back in incident light and the viewing of the security element in transmitted light result in different motifs in each case.

From DE 10 2008 028 187 there is known a further security element for a window area of a data carrier, which upon viewing in incident and transmitted light shows different motifs to a viewer. Therein, a per se known interference thin film made from a partially transparent layer, a reflective layer and an intermediate dielectric layer is suitably changed. It is proposed to provide gaps in the partially transparent layer so that when viewing the partially reflective layer in incident light, these gaps in the surrounding area, for example an area showing a color shift effect, are recognizable as specular surfaces in which the impinging light is mirrored at the reflective layer without producing an interference effect. It is further proposed to provide the reflective layer with small gaps not recognizable with the naked eye, which upon viewing in transmitted light ensure a certain translucency of the otherwise completely opaque, reflective layer. It is additionally proposed to do without such gaps in certain areas, so that upon viewing in transmitted light there results for example an opaque motif on a translucent background. Since the gaps in the reflective layer are independent of the gaps in the partially reflective layer, different motifs for the viewing in incident and transmitted light can thus be produced.

Furthermore, it is known, for example, to apply grid dots onto the front and back of a translucent substrate, which are shifted in such a way that upon perpendicular viewing there results an all-over general impression, while upon oblique viewing one can look through between the grid dots, so that there results a partially transparent impression for the viewer.

The known security elements, which upon viewing in incident and transmitted light produce different motifs, without exception have a complex, multi-layer structure and require corresponding complex manufacturing processes. Thus, in the last-mentioned prior art it is required that the front-side and back-side grid dots have a high local accuracy to each other, in order to obtain the desired impression upon perpendicular and oblique viewing. Furthermore, when the aforementioned covering white grid dots are used, a high fitting accuracy of the at least three ink layers to each other is required. Such a high fitting accuracy is particularly difficult to ensure, when the colored ink dots are printed wet on wet onto the grid dots of opaque white. Furthermore, there results, due to the double printing, a high total thickness of the applied ink layers, making them easy to abrade or soil. If the printing is effected by offset method, additionally, the necessary ink splitting between printing plate onto blanket and blanket onto substrate can only be ensured with difficulties.

It is therefore the object of the present invention to provide a security element, which in incident and transmitted light shows different information to the viewer and which has a simple structure and thus allows a simple manufacturing. It is further an object of the invention to provide a corresponding transfer element and a corresponding data carrier.

This object is achieved by a security element, a data carrier, a transfer element as well as a manufacturing method with the features of the independent claims. The dependent claims relate to preferred embodiments and developments of the invention.

The security element according to the invention comprises a translucent, preferably transparent substrate, for example in the form of a foil element made of plastic material serving as a carrier foil. The substrate has a first and second partial area, the two partial areas, upon viewing in incident light, producing to a viewer a similar, in the ideal case identical visual impression, in particular color impression, upon viewing in transmitted light, however, producing impressions different from each other. According to the invention, the first partial area, upon viewing in transmitted light, produces to the viewer a brighter visual impression compared to the second partial area. Accordingly, the second partial area produces to the viewer a darker visual impression compared to the first partial area.

The two partial areas are disposed at least in certain areas in precise fit next to each other and thus, upon viewing in incident light, directly adjoin each other, so that at least in certain areas there are not located any unprinted areas or gaps between the partial areas. The two partial areas thus form a contiguous total area. Preferably, they do not overlap.

Due to the substantially identical visual impression produced upon viewing in incident light, the first and the second partial area, upon viewing in incident light, are only slightly distinguishable for a viewer, ideally, in particular under ideal light conditions, not distinguishable. In incident light, to the viewer is thus conveyed first information composed of the entirety of both partial areas. Upon viewing in transmitted light, however, both partial areas are clearly distinguishable for the viewer, because of the differently bright visual impressions produced. Upon viewing in transmitted light, to the viewer is thus conveyed second information which results from the differently appearing first and second partial areas. Thus, a security feature is created which, upon viewing in incident and transmitted light, can convey different information to a viewer.

Such partial areas can be realized according to a first embodiment by the first and second ink layers being applied in the first and second partial areas each with different degrees of coverage. For example, the second ink layer is applied all-over in the second partial area, while the first ink layer is applied in a grid-like manner in the first partial area. Both ink layers are covering ink layers, which upon viewing in transmitted light produce, at least when a sufficient layer thickness is given, an opaque visual impression. The visual impression of the second partial area produced upon viewing in incident light is based, because of the second ink layer's all-over print, mainly, preferably exclusively on the visual impression of the printing ink used for the second ink layer. In the first partial area, the structure size of the grid is chosen such that the individual grid elements, for example grid dots, grid lines or dot-like recesses, are not recognizable with the naked eye. The characteristic dimensions of the grid elements, such as size and spacing, for this purpose are preferably smaller than 100 μm or smaller than 50, 20, 10, 5, 2 or 1 μm. Therefore, the visual impression the first partial area produces to the viewer is based on a mixture of the impression produced by the applied first ink layer, possibly additionally influenced by a background ink, and depends on the degree of coverage (in percent) of the first ink layer in the first partial area. The hue of the printing inks used for the two ink layers is chosen such that both partial areas, upon viewing in incident light against a white background, produce to a viewer the same visual impression. In the simplest case, for both ink layers there are used colorless printing inks, for the grid-like print in the first partial area being used a darker printing ink in contrast to the printing ink used for the all-over print, that is, a darker shade of grey, so that upon viewing in incident light the first partial area's visual impression mixed of the darker grid color and the white background is like the impression of the all-over print in the second partial area.

Upon viewing in transmitted light, the second partial area appears opaque because of the all-over printing of the covering ink, while in the first partial area the light shines through the gaps in the grid and is perceptible to the viewer as a bright visual impression. Thus, upon viewing in transmitted light, in the first partial area there results a brighter visual impression despite the darker printing ink used. Preferably, both ink layers have a comparable or identical opacity.

Instead of colorless printing inks there can also be used colored printing inks. In this case, in a similar way, by a suitable choice of the printing inks there can be produced, upon viewing in incident light, a visual color impression identical in the first and the second partial area, while upon viewing in transmitted light there are produced differently bright visual impressions.

Instead of the all-over print, in the second partial area there can also be used a grid-like print, which, however, differs from the grid in the first partial area in the degree of coverage (in percent).

According to a second preferred embodiment for producing the optically differently appearing partial areas, the first ink layer applied in the first partial area is a glazing ink layer and the second ink layer applied in the second partial area is a covering ink layer. Both ink layers can be applied in a grid-like manner. However, this second preferred embodiment allows in a simple and thus preferred manner an all-over application of both ink layers in both partial areas. For this, the printing inks for both ink layers are chosen such that from both partial areas, upon viewing in incident light, there results the same visual color impression, while upon viewing in transmitted light the second, covering ink layer appears darker than the glazing ink layer. This can be realized in that both printing inks have the same base printing ink. As a printing ink for the first ink layer there is then used a mixture of this base printing ink and a colorless, transparent printing ink, preferably transparent white, whereas for the printing ink of the second ink layer there is used a mixture of the base printing ink and a colorless, covering printing ink, preferably opaque white.

With a suitable choice of the mixture ratios of the base printing ink to transparent white or opaque white, respectively, the use of opaque white or transparent white does not play a role for the impression produced upon viewing in incident light, so that to the viewer both partial areas produce a substantially identical visual impression. Opaque white has, compared to transparent white, a significantly reduced light transmission, so that the second partial area, upon viewing in transmitted light, is recognizable as a preferably opaque area, while the first partial area appears distinctly brighter due to the higher light transmission of the transparent white. A shadowing or darkening such as in the first partial area does not occur or occurs only to a limited extent in the second partial area upon viewing in transmitted light. The degree of the shadowing or darkening of the second partial area depends on the opacity of the opaque white ink used and the layer thickness of the second, covering ink layer.

In a preferred embodiment there is used a colored base printing ink. Thus, there results for the viewer, upon viewing in incident light, in both partial areas visually the same colored color impression. Since the first ink layer due to the use of transparent white is glazing, the first partial area has also in transmitted light substantially the hue of the base printing ink. Whereas in the second partial area, in transmitted light, the covering, preferably opaque impression of the opaque white ink is predominant, since the light/dark contrast emerging with the first partial area is perceived stronger by the viewer. Moreover, the eye of the viewer carries out a white light balance with the first partial area, so that colored portions still remaining in the second partial area step back even more. In addition, in the second partial area also colored pigments are covered by the covering pigments of the opaque white ink, so that in the second partial area, upon viewing in transmitted light, the colored visual impression is effectively suppressed. The second partial area, therefore, despite the colored ink layer appears grey to black in transmitted light.

In this case, in transmitted light the first and second partial areas thus differ not only in the brightness but also in the colored color impression, the first partial area showing a higher strength of color, i.e. a more intense color, and the second partial area in transmitted light appearing substantially colorless. This color change between incident light and transmitted light in the second partial area can be adjusted by a suitable mixture ratio between base printing ink and opaque white, preferably, the portion of opaque white in the printing ink for the second ink layer being much higher than the portion of the base printing ink. Here, the ideal portion of opaque white generally depends on the opacity of the base printing ink or its colored pigments. This opacity depends for example on the chemical structure of the pigments and the wetting with the surrounding binder.

According to a further embodiment, the first ink layer has in the first partial area a lower layer thickness than the second ink layer in the second partial area. For applying the two different ink layers, the same printing ink can be used here. Both ink layers may also have the same degree of coverage, for example, be applied in the same grid or preferably applied all-over.

Upon viewing in incident light, the different layer thicknesses especially in the case of covering ink layers are not perceived, so that there results a substantially identical visual impression in both partial areas.

However, because of the different layer thicknesses the two partial areas have light transmissions different from each other. For this, the two layer thicknesses are suitably chosen, so that the different light transmissions can be perceived by a viewer.

All described variants of embodiments of the security element according to the invention are preferably characterized by a merely single-layer printing of the two ink layers onto the translucent substrate. On the one hand, this reduces the print height of the printed layer, which reduces the risk of abrasion and soiling. On the other hand, by applying only one printed layer the manufacturing method is correspondingly simplified. Even in the case of a grid-like application of the printing inks, the grid dots, contrary to the known security elements, do not have to be applied in precise fit to, for example, other grid dots. Furthermore, due to the single-layer printing the problem of a wet on wet printing does no longer exist.

All described variants of embodiments of the security element according to the invention can be combined with each other in a suitable manner depending on the desired effects. For example, in the first partial area there can be provided a glazing ink layer applied in a grid-like manner and in the second partial area a covering ink layer applied all-over with possibly different layer thickness.

Further, there can also be provided three or more partial areas, which upon viewing in incident light produce an identical visual impression, but upon viewing in transmitted light produce differently bright visual impressions in each case. Thus, transmitted-light information having different gradations can be created.

The two partial areas can be disposed on the translucent substrate's front and back in each case. But preferably they are disposed on a common first surface side of the translucent substrate and lie there end to end. Thus, there does not take place an overprint of the two ink layers and both partial areas form a contiguous common total area.

In a particularly preferred embodiment, the total area, upon viewing in incident light, does not convey any information, so that only in transmitted light information is given to the viewer. Thus, already the presence of transmitted-light information is hidden.

In a further embodiment, on the back-side surface side located opposite the first surface side, there is disposed a further third ink layer, which upon viewing in transmitted light overlaps with at least the first or second partial area.

For example, the third ink layer is applied in a third partial area, which corresponds to the total area of first and second partial area on the front located opposite. If the third ink layer is glazing, there results for the viewer, upon viewing in incident light, a color impression which corresponds to a combination of back-side, glazing ink layer with the front-side ink layers as a background. Therefore, also upon viewing the back in incident light, there results a substantially uniform color impression, while in transmitted light the covering, preferably opaque second partial area of the front is well recognizable. Thus, upon viewing in transmitted light from the back, there results laterally reversed the same transmitted-light information as upon viewing in transmitted light from the front. Both pieces of information lie, when viewing the front and the back in transmitted light, in precise fit to each other, without requiring a print in precise fit.

Furthermore, the ink layer applied on the back in the third partial area can be covering, so that, upon viewing in incident light, there results on the back again a uniform color impression, which here, however, depends merely on the color impression of the covering ink layer applied on the back. In transmitted light the covering ink layer applied on the back first appears opaque or at least having a perceptibly reduced light transmission. With a suitable choice of the opacities of the covering ink layer in the second partial area on the front and the covering ink layer applied on the back, the result may be a perceptibly increased opacity in the area of the overlapping of the covering ink layers, with which also upon viewing in transmitted light the transmitted-light information of the front-side partial areas disposed over the third partial area is still visible.

The third ink layer in the third partial area can be applied all-over or in a grid-like manner. The third partial area may also have a form different from the front-side total area of the first and second partial area. This results in further design options which influence the perception upon viewing the front and the back in incident light, as well as upon viewing in transmitted light.

Further, on the back of the translucent substrate there can be provided a further fourth partial area with a fourth ink layer different from the third ink layer. The third and fourth partial area form on the back, similar to the first and second partial area on the front, a contiguous total area and produce, upon viewing in incident light, on the back a substantially identical visual impression, the third partial area, upon viewing in transmitted light, producing a brighter visual impression compared to the fourth partial area.

The back-side ink layers can be covering and/or glazing ink layers, grid-like and/or applied all-over and/or have different layer thicknesses. The choice of the hue, of the degrees of covering and coverage and also of the outlines of the back-side partial areas is effected suitable to the first and second partial areas on the front of the security element. In particular, the front-side and the back-side partial areas, upon viewing in incident light, can have identical or different hues.

For example, the back can be provided with the same, possibly laterally reversed incident-light and transmitted-light information as the front. This results in for example a stronger opacity of the transmitted-light information. Here, the visual impressions, in particular the color impressions which result on the front and back upon viewing in incident light, are preferably identical, which in the simplest case can be achieved in that, on the one hand, in the first and third partial area and, on the other hand, in the second and fourth partial area identical ink layers are applied in each case.

In a further preferred embodiment the back-side total area of third and fourth partial area is disposed congruent to the front-side total area of first and second partial area. By contrast, the second and fourth partial areas do not lie congruent to each other, but have a form different from each other and/or are shifted relative to each other. As a result, front and back upon viewing in incident light convey identical, possibly laterally reversed information. Upon viewing in transmitted light, however, the darker opaque areas of the second and fourth partial area are recognizable, for the reason of which there results in areas where the second and fourth partial area lie on top of each other an additional reduction of the light transmission and thus a contrast enhancement. Particularly preferred, the fourth partial area, upon viewing in transmitted light, lies completely within the second partial area, for the reason of which there results a two-step lookthrough image, similar to a watermark.

Furthermore, within the different partial areas on front and/or back there can be provided gaps in the form of non-printed areas. Furthermore, instead of the covering ink layer there can also be used pure opaque white (without the addition of a base printing ink).

Preferably, on the translucent substrate there is provided in a fifth partial area a fifth ink layer and in a sixth partial area a sixth ink layer different from the fifth layer. The fifth and sixth partial area, upon viewing in incident light, form a contiguous total area which is disposed next to the contiguous total area of first and second partial area. The two total areas do not overlap each other. Fifth and sixth partial area further produce a substantially identical visual impression, which, upon viewing in incident light, differs from the visual impression of the first and second partial area. Upon viewing in transmitted light, the fifth partial area, compared to the sixth partial area, produces a brighter visual impression.

The fifth and sixth ink layer can be covering and/or glazing ink layers, be grid-like and/or applied all-over and/or have different layer thicknesses. This results in further degrees of freedom for the design and the information production of the security element.

Upon viewing in incident light, the information for the viewer is composed here of the total area of first and second partial area, on the one hand, and the adjacent total area of fifth and sixth ink layer, on the other hand. In transmitted light, there results for the viewer information which is composed of up to four different visual impressions: the first and fifth partial area are distinguishable due to their generally different brightness. When colored glazing ink layers are used, they are also distinguishable due to their hue (corresponding to the base printing ink used). The second and sixth partial area, likewise, are distinguishable due to their generally different opacity.

Preferably, the two total areas are disposed, at least in certain areas, in precise fit next to each other and thus, upon viewing in incident light, directly adjoin each other, so that at least in certain areas there are not located any unprinted areas or gaps between the total areas. The two total areas thus form a large, contiguous total area.

Advantageously, then the visual impression, produced upon viewing in transmitted light, of first and fifth partial area, on the one hand, and second and sixth partial area, on the other hand, is chosen substantially identical, and the outlines of the partial areas are suitably chosen, so that upon viewing in transmitted light the first and fifth partial area, on the one hand, and the second and sixth partial area, on the other hand, appear as contiguous areas in each case. This results in transmitted-light information which is composed of only two different visual impressions, which, however, differs from the incident-light information which is also composed of two different visual impressions.

Advantageously, the first, second, fifth and sixth partial area are printed onto the first surface side of the translucent substrate in a contiguous and end-to-end manner.

In a further preferred embodiment, the two total areas are disposed next to each other only partly in precise fit or not at all in precise fit. The total area of the additional ink pair is thus disposed spaced apart from the total area of the first ink pair, so that there are at least two non-contiguous total areas. The additional ink pair here describes a further motif or complements the motif of the first ink pair.

Particular advantage of this embodiment is thus that the additional ink pair is not disposed over the first ink pair or does not overlap this. The one or more additional ink pairs can be disposed here on the front, back or on both sides of the security element.

Advantageously, the printing inks used for the different ink layers comprise, besides the visually recognizable dyes, also other in particular machine-detectable feature substances, such as for example IR absorbers or luminescent substances. These can be introduced in both the printing ink for the covering ink layer and also the printing ink for the glazing ink layer.

Furthermore, the front and/or the back of the translucent substrate of the security element can be additionally provided with optically variable effect layers, which preferably are highly translucent, for example an interference thin film, a layer of pigments of such interference films, a layer with interference pigments based on a mica, such as for example an Iriodine pigment of the Merck company, a liquid crystal ink layer, a transparent or semi-transparent metallization or also a diffraction structure, for example in the form of an embossed hologram.

In a further preferred embodiment, on at least one side of the security element there is applied at least a glossy or strongly matted lacquer, which upon tilting produces further information. The surface printed with the lacquer or the ink is here preferably applied in the form of a so-called spot lacquering and thus has an own motif. It may be disposed overlapping, partly overlapping or only within the area of the covering and non-covering ink pairs.

If the area coated with the optically variable effect layer or the glossy or strongly matted lacquer is smaller than the surface of covering and non-covering visually equal ink pairs, the result is, advantageously, further information in transmitted light, which is due to the semi-transparency of the optically variable ink or metallic coatings.

In a further preferred embodiment, the optically variable ink or the metal vapor deposition is individualized by laser without changing the opacity of the respective coating. This effect is known, for example, from the prints WO 2008/080499, DE 10 2008 028 187 and DE 10 2008 027 952, the disclosure of which in this respect is fully incorporated herein.

The security element can be configured as a transfer element, by the ink layers being detachably applied to the first surface side. Alternatively, the security element can be detachably applied to a carrier layer.

The security element is preferably configured for the application onto a window area of a data carrier. The translucent substrate here is preferably configured as a carrier foil for example in the form of a foil element.

The security element can be finished before the application onto the data carrier and for this purpose, for example, be printed. For manufacturing a data carrier having a security element, preferably over a window area of the data carrier, however, there can also first be applied a still unfinished security element, for example an unprinted carrier foil element, onto the data carrier. Not until after the application onto the data carrier, the still missing ink layer(s) are applied in the different partial areas of the translucent substrate. Preferably, the different ink layers are applied here not only onto the translucent substrate, but also onto the surface of the data carrier itself, which can be effected in one single procedure step. In this way, there can be achieved a good optical integration of the security element or of the translucent substrate of the security element in the design of the data carrier.

It is further of advantage when the different motifs of the security element or at least one of these motifs on the data carrier is printed again, preferably outside the window, which facilitates the authenticity check of such a data carrier by a simple comparison of two motifs preferably printed closely next to each other.

The visually equal ink pairs with different opacity or transparency are preferably applied by gravure, flexo, inkjet, relief or offset printing process. If an alignment of the ink pairs in exact register is to be achieved, there is preferably used the simultaneous printing in offset or relief printing process. Effect inks are preferably applied by gravure, screen or flexographic printing process.

The grid structures used for the covering and non-covering inks of one or more ink pairs may also be part of a moiré grid element, which can be verified for example by means of photographic film, display or mobile phone display in transmitted light or in top view on a print. In this regard, reference is made to for example the print WO 2009/019038 A1, the disclosure of which is fully incorporated herein.

In a further preferred embodiment, the inks of the ink pairs are replaced, at least in partial areas, by one or more metallic layers, which are preferably vapor-deposited onto the substrate. A different opacity between the respective metallic layers is produced here by either different thicknesses or by a grid. In the first-mentioned case, the metallization of the first partial area, which upon viewing in transmitted light produces a brighter visual impression compared to the second partial area, has a lower layer thickness than the metallization of the second partial area. If, however, the visual impression different in transmitted light is to be produced by a grid, the grid areas are produced preferably by demetallization. For this, there is preferably used a washing method as described for example in the print WO 99/13157, the disclosure of which in this respect is fully incorporated herein.

Further exemplary embodiments and advantages of the invention are explained in the following by way of example with reference to the accompanying Figures. The examples represent preferred embodiments to which the invention shall be in no way restricted. The shown Figures are schematic representations which do not reflect the real proportions, but rather serve for the improvement of clarity regarding the various exemplary embodiments.

The Figures schematically show in detail:

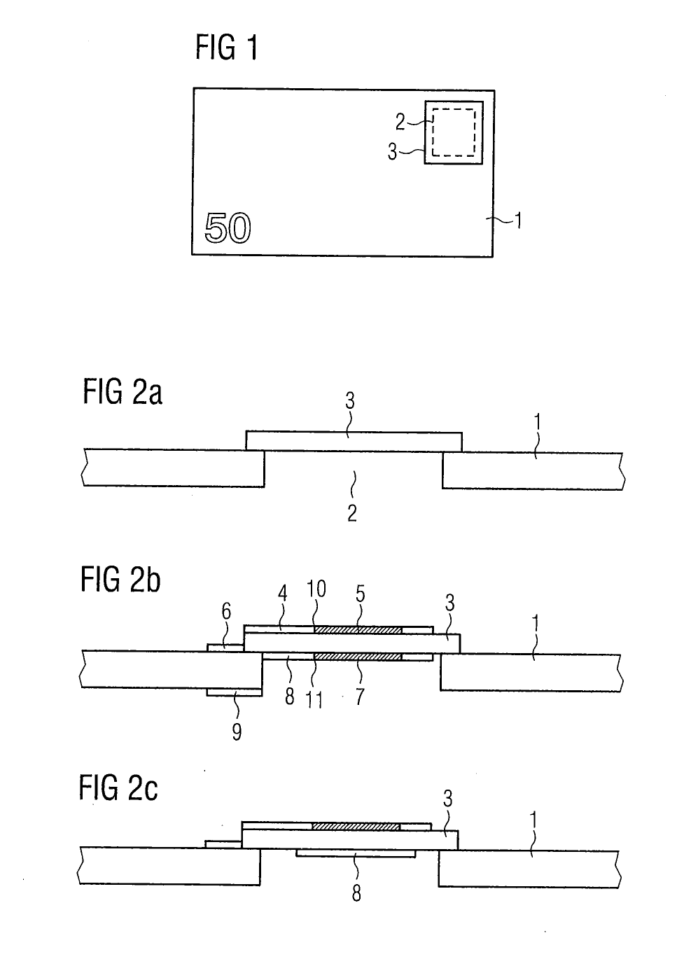

FIG. 1 a bank note with a security feature;

FIGS. 2a to 2c cross sections through a security feature; and

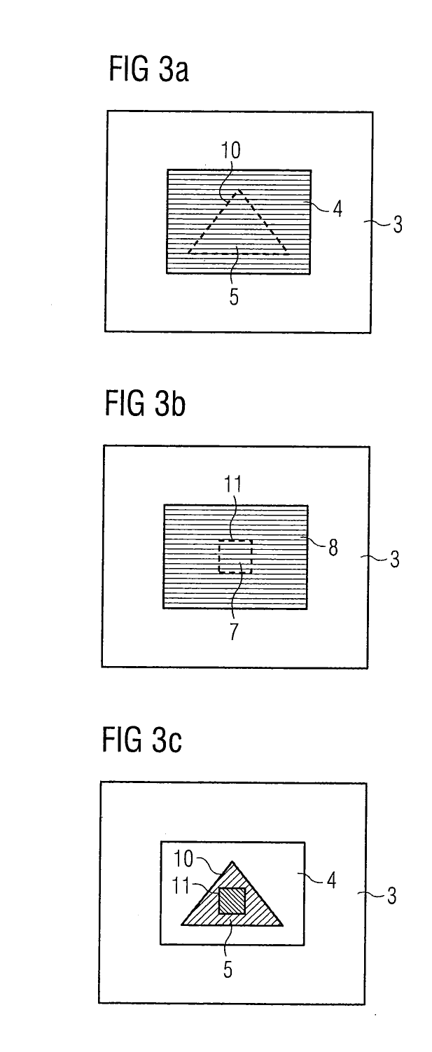

FIGS. 3a to 3c top views onto and views through such a security element.

In FIG. 1 there is represented a bank note 1 as a data carrier. This bank note comprises a window area 2 in the form of a gap or a hole, over which is applied a transparent carrier foil 3. The bank note 1 itself is opaque, so that upon viewing in transmitted light, the visual impression to the viewer is only due to the security element, that is, to the printed transparent carrier foil 3.

In FIG. 2a there is represented a cross section through the window area 2 of the bank note 1. The transparent carrier foil 3 of the security element is applied here over the window area 2 of the data carrier already before the application of the various ink layers, that is, before the finishing of the security element.

After the application, the translucent substrate 3 is printed in a first partial area 4 with a glazing, translucent ink layer and in a second partial area 5 with a covering, opaque ink layer. In the edge areas the print here is effected beyond the carrier foil 3, so that also in the partial area 6 there is disposed an ink layer directly on the bank note 1. In a substantially similar manner, the carrier foil's 3 back lying below is printed with a covering ink layer in a partial area 7 and printed with a glazing ink layer in a partial area 8. In area 9, too, the print is effected directly on the back of the banknote 1. In the shown exemplary embodiment, on both the back and the front of the bank note there are printed, end to end along the abutting edges 10 and 11, the various partial areas, in which the glazing and the covering ink layer is applied in each case, so that on the front and back a common total area is the result in each case, which in incident light produces a uniform visual impression in each case. Furthermore, the partial areas 5, 7, in each of which is applied the covering ink layer, lie congruently to each other on the front and back of the carrier foil 3.

The exemplary embodiment shown in FIG. 2c substantially corresponds to the exemplary embodiment shown in FIG. 2b. On the back of the carrier foil 3, however, there was printed only one single glazing colored ink layer in partial area 8, which is not congruent to the front-side partial areas 4 and 5.

FIG. 3a shows a top view onto the front of a security element. There is represented the visual impression which results upon viewing the front in incident light. For a better understanding, the abutting edge 10 between the partial areas 4, 5 with the covering and the glazing ink layer is drawn with a broken line. These two partial areas upon viewing in incident light, however, are not distinguishable, since both partial areas in this case produce an identical color impression. Therefore, the viewer does not perceive the abutting edge 10, and the result is the uniform visual impression indicated by the uniform hatching.

FIG. 3b shows a top view onto the back of the security element of FIG. 3a. There is represented the visual impression which results upon viewing the back in incident light. Similar to the top view onto the front, which is shown FIG. 3a, here again the result is a uniform visual impression as indicated with the hatching. With the broken line there is represented the abutting edge 11 of the partial areas 7, 8, lying end to end, with the covering and the glazing ink layer, respectively, which, however, is not perceivable to the viewer upon viewing in incident light.

FIG. 3c shows a view through this security element, that is, the visual impression which results upon viewing in transmitted light. Here, for the viewer, the bright area 4 having the glazing ink layer clearly differs from the opaque, darker area 5 having the covering ink layer. The abutting edge 10 is therefore clearly recognizable and conveys to the viewer a transmitted-light information which differs from the incident-light information shown in FIG. 3a. Furthermore, in transmitted light the opaque partial area 7 is perceptible, which upon viewing in transmitted light completely lies within partial area 5 and produces an increased opacity.

In the exemplary embodiment there are used inks for simultaneous printing or mixtures of at least two inks for simultaneous printing. As a printing ink for the glazing ink layer there is used a mixture of 30% transparent white (GSI number: 68 0170) and 70% blue (GSI number: 68 0141), while for the covering ink layer there are used 85% opaque white (GSI number 68 0172) and 15% blue (GSI number: 68 0141). The GSI numbers refer to the coding of inks for simultaneous printing of the manufacturer Gleitsmann Security Inks. The opaque white ink used contains covering TiO₂ pigments. In the exemplary embodiment, the opaque white portion in the covering printing ink is much greater than the transparent white portion in the glazing ink. Nevertheless, the corresponding ink layers, upon viewing in incident light, produce the same visual colored color impression.

1-18. (canceled)

19. A security element for a data carrier, comprising a translucent substrate in the form of a transparent foil element which includes a first partial area with a first ink layer and a second partial area with a second ink layer different from the first ink layer, said first and second partial areas producing respective visual impressions having respective brightness levels when viewed in transmitted light, wherein the first and second partial areas, upon viewing in incident light, form a contiguous total area and produce a substantially identical visual impression, and wherein the first partial area, upon viewing in transmitted light, produces a visual impression having a brightness level higher than the brightness level of the second partial area.

20. The security element according to claim 19, wherein the first ink layer is applied in a grid-like manner and has a lower degree of coverage on the translucent substrate than the second ink layer, and the first and second ink layers are covering ink layers.

21. The security element according to claim 19, wherein the first ink layer is glazing and comprises a mixture of a colored printing ink and a colorless, transparent printing ink, and the second ink layer is a covering ink layer and comprises a mixture of the colored ink and a colorless, covering printing ink.

22. The security element according to claim 19, wherein the first ink layer has a lower layer thickness than the second ink layer, and the first and second ink layers are covering ink layers.

23. The security element according to claim 19, wherein the first and the second partial areas are disposed on a common first surface side of the translucent substrate.

24. The security element according to claim 23, wherein on a second surface side of the translucent substrate, which is located opposite the first surface side, there is disposed a third partial area with a third ink layer, said third partial area being disposed at least partly overlapping with the first and/or second partial areas.

25. The security element according to claim 24, wherein, on the second surface side there is disposed a further, fourth partial area with a fourth ink layer different from the third ink layer, wherein the third and fourth partial areas form on the second surface side a contiguous total area and produce a substantially identical visual impression, said third and fourth partial areas producing respective visual impressions having respective brightness levels when viewed in transmitted light, and wherein the third partial area, upon viewing in transmitted light, produces a visual impression having a brightness level higher than the brightness level of the fourth partial area.

26. The security element according to claim 25, wherein the first partial area is disposed congruently to the third partial area and/or the second partial area is disposed congruently to the fourth partial area.

27. The security element according to claim 25, wherein the contiguous total area on the first surface side is disposed congruent to the contiguous total area on the second surface side; the second and fourth partial areas, upon viewing in transmitted light, differ in form and/or position; and upon viewing in incident light, the first, second, third and fourth partial areas produce a substantially identical visual impression.

28. Security element according to claim 19, wherein the translucent substrate comprises a fifth partial area with a fifth ink layer and a sixth partial area with a sixth ink layer different from the fifth ink layer, wherein the fifth and sixth partial areas, upon viewing in incident light, form a contiguous total area which is disposed next to the contiguous total area of first and second partial areas, and produce a substantially identical visual impression which differs from the visual impression of the first and second partial areas upon viewing in incident light, said fifth and sixth partial areas producing respective visual impressions having respective brightness levels when viewed in transmitted light, and wherein upon viewing in transmitted light the fifth partial area produces a visual impression having a brightness level higher than the brightness level of the sixth partial area.

29. The security element according to claim 28, wherein the first, second, fifth and sixth partial areas in incident light form a contiguous total area and preferably the first, second, fifth and sixth partial areas are disposed on a common, first surface side of the translucent substrate.

30. The security element according to claim 23, and being formed as a transfer element with the ink layers on the first surface side being detachably applied.

31. A transfer element, comprising a security element according to claim 19, which is detachably applied onto a carrier layer.

32. A data carrier comprising a security element according to claim 30.

33. The data carrier according to claim 32, wherein the security element is applied over a window area of the data carrier.

34. A method for manufacturing a security element for a data carrier, comprising the steps
providing a translucent substrate,
applying a first ink layer in a first partial area of the translucent substrate,
applying a second ink layer different from the first ink layer in a second partial area of the translucent substrate,
so that the first and second partial areas, upon viewing in incident light, form a contiguous total area and produce a substantially identical visual impression, and the first partial area, upon viewing in transmitted light, produces a brighter visual impression compared to a brightness of a visual impression of the second partial area.

35. A method for manufacturing a data carrier having a security element, comprising the method for manufacturing a security element according to claim 34, wherein the translucent substrate is applied onto the data carrier before the application of the first and second ink layer.

36. The method according to claim 35, wherein first and/or second ink layer is/are additionally applied onto a surface of the data carrier.
